(19) United States
(12) Patent Application Publication
(10) Pub. No.: US 2006/0068196 A1
(43) Pub. Date: Mar. 30, 2006

(54) High-frequency magnetic material, producing method for the same and high-frequency magnetic device

(75) Inventors: Seiichi Suenaga, Kanagawa (JP); Takayuki Fukasawa, Tokyo (JP); Tomohiro Suetsuna, Kanagawa (JP); Koichi Harada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/229,725

(22) Filed: Sep. 20, 2005

(30) Foreign Application Priority Data
Sep. 24, 2004 (JP) P2004-278271

(51) Int. Cl. B32B 15/00; H01F 1/04; H01F 1/14; C01G 49/08; B32B 5/16

(52) U.S. Cl. 428/328; 428/692.1; 252/62.55; 252/62.56

(57) ABSTRACT

A high-frequency magnetic material includes: metal particles of one of Fe and Co or alloy particles based on at least one of Fe and Co; and an oxide phase containing a matrix phase and a metal oxide having a larger valence than the matrix phase. The matrix phase contains a non-reducible metal oxide and the metal oxide having a larger valence than the matrix phase forms a solid solution with the matrix phase.

### CROSS-REFERENCE TO RELATED APPLICATIONS

This application is based upon and claims the benefit of priority from the prior Japanese Patent application No. 2004-278271, filed Sep. 24, 2004, the entire contents of which are incorporated herein by reference.

### BACKGROUND OF THE INVENTION

1. Field of the Invention

The present invention relates to a high-frequency magnetic material that is useful, for example, as a magnetic member used in a high frequency range of 10 MHz 3.5 or more, particularly from 100 MHz to a GHz order. The present invention also relates to a producing method for the high-frequency magnetic material and a high-frequency magnetic device using the high-frequency magnetic material.

2. Description of the Related Art

The applications using a magnetic material member are being expanded, and the magnetic material is increased in importance thereof. Examples of the applications include an inductance element, an electromagnetic wave absorbing material and a magnetic ink. Examples of the magnetic material used as an inductance element in a high frequency range of 1 MHz or higher include ferrite and an amorphous alloy. The magnetic materials show little loss (imaginary part of magnetic permeability (μ″) is small), have high real part of magnetic permeability (μ′) and exhibit good magnetic property in a frequency range of from 1 to 10 MHz. However, the magnetic materials have a reduced real part of magnetic permeability (μ′) in a higher frequency range of 10 MHz or higher so that they cannot provide sufficient property. In order to solve the problem, an inductance element is being actively developed in such a manner that a soft magnetic material with high magnetic permeability is formed by a thin film technology, such as a sputtering method and a plating method. It has been confirmed that the inductance element exhibits excellent property in a high frequency range of 10 GHz or higher. However, the thin film technology, such as the sputtering method, requires a large scaled manufacturing facility and is insufficient in cost and yield since the film thickness is necessarily controlled precisely. Also, the inductance element has another problem of lacking in long-term thermal stability in magnetic property under high temperature and high humidity conditions.

Examples of the high-frequency magnetic material also include an electromagnetic wave absorbing material The electromagnetic wave absorbing material utilizes its high imaginary part of magnetic permeability (μ″) and absorbs noise occurring upon using an electronic device at a high frequency, so as to reduce failures of the electronic device, such as irregular operation. Examples of the electronic device include a semiconductor element, such as an IC chip, and various kinds of communication equipments. The electronic devices include various kinds thereof used in a frequency range of from 1 MHz to several GHz and in a higher frequency range of several tens GHz or more, and there is such a tendency in recent years that electronic devices used in a high frequency range of 1 GHz or higher are being increased in number. As an electromagnetic wave absorbing material for electronic devices used in the high frequency range, such materials have been used that is obtained by mixing a resin with ferrite particles, carbonyl iron particles, FeAlSi flakes, FeCrAl flakes or the like. However, these materials do not necessarily exhibit sufficient property in a high frequency range of 1 GHz or higher since μ′ and μ″ extremely decrease.

In recent years, a composite magnetic material obtained by integrating magnetic metal particles with ceramics are proposed as an electromagnetic wave absorbing material used in a high frequency range of 1 GHz or higher as shown, for example, in JP-A-2001-358493. The material is produced by the mechanical alloying method and thus requires a prolonged mixing process for uniformly reacting the magnetic metal particles with the ceramics. In the case where a large amount (for example 10 kg or more) of the material is to be produced at a time by the mechanical alloying method, in particular, a longer period of time is required for mixing, and the yield is tend to be insufficient. Also, there is a problem of lacking in long-term thermal stability in magnetic property under high temperature and high humidity conditions.

### BRIEF SUMMARY OF THE INVENTION

According to one embodiment of the present invention, there is provided a high-frequency magnetic material comprising:
metal particles of one of Fe and Co or alloy particles based on at least one of Fe and Co; and
an oxide phase comprising: a matrix phase containing a non-reducible metal oxide; and a metal oxide having a larger valence than the matrix phase, the metal oxide forming a solid solution with the matrix phase.

According to another embodiment of the present invention, there is provided a method for producing a high-frequency magnetic material, comprising:

a step for obtaining a composite oxide having an average particle size of 10 nm to 1 μm by mixing, pulverizing and sintering a non-reducible metal oxide, a metal oxide selected from Al₂O₃, Sc₂O₃, Cr₂O₃ and V₂O₃ in a content of 0.001 to 0.1% by mole based on the non-reducible metal oxide, and a metal oxide containing at least one of Fe and Co; and

a step for reducing the composite oxide to deposit a metal or alloy particles containing at least one of Fe and Co.

According to still another embodiment of the present invention, there is provided a high-frequency magnetic device comprising:

a magnetic layer;

a high-frequency magnetic substrate comprising

metal particles of one of Fe and Co or alloy particles based on at least one of Fe and Co, and

an oxide phase comprising: a matrix phase containing a non-reducible metal oxide; and a metal oxide having a larger valence than the matrix phase, the metal oxide forming a solid solution with the matrix phase; and

a wiring on the high-frequency magnetic substrate.

### BRIEF DESCRIPTION OF THE DRAWINGS

FIG. 1 is a cross sectional view of a high-frequency magnetic material of one embodiment of the invention;

FIG. 2 is a cross sectional view of a high-frequency magnetic material in which the matrix phase is composed of oxide particles; and

FIG. 3A illustrates a high-frequency magnetic device showing one embodiment of the present invention, and FIG. 3B is a cross sectional view taken along IIIB-IIIB in FIG. 3A.

### DETAILED DESCRIPTION OF THE INVENTION

The invention will be described with reference to embodiments below.

### First Embodiment

A first embodiment of the invention will be described. A high-frequency magnetic material of the embodiment contains an oxide phase, and metal particles containing at least one of Fe, Co, and an alloy based on Fe or Co, in which the oxide phase includes a matrix phase containing a non-reducible metal oxide, and a metal oxide has a larger valence than the matrix phase and forming a solid solution with the matrix phase.

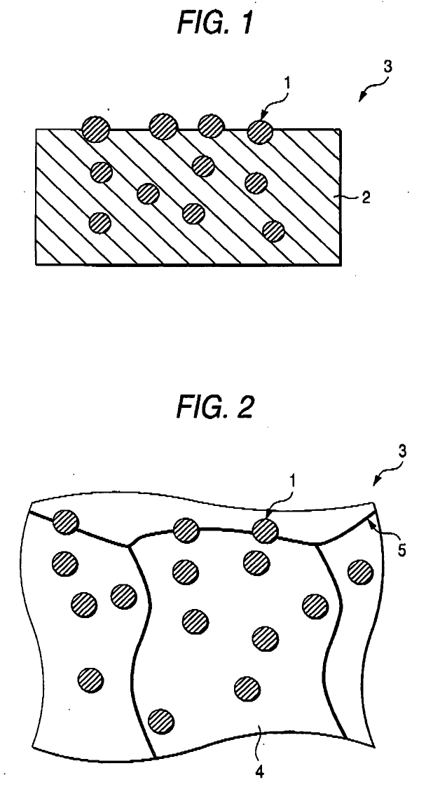

FIG. 1 is a cross sectional view of a high-frequency magnetic material taken along the thickness direction, in which the high-frequency magnetic material 3 contains metal particles 1 in the interior of the oxide phase 2 and a metal oxide having a larger valence than the matrix phase forms a solid solution with the matrix phase.

The alloy based on at least one of Fe and Co includes an alloy that contains at least one of Fe and Co, part of which is replaced with another metal can be cited. In addition, it is preferred that such an alloy contains at least one of Fe and Co in 50 atomic % or more of the total alloy.

Such a high-frequency magnetic material exhibits no loss except ferromagnetic resonance loss, having a high magnetic permeability even in high frequency regions, and its ferromagnetic resonance frequency reaches to as high as several GHz. Accordingly, in the frequency region below the ferromagnetic resonance frequency, it has a high μ′ and a low μ″, which enables applications such as inductance elements, etc. On the other hand, at the vicinity of the ferromagnetic resonance frequency, it has a low μ′ and a high μ″. Thus, it can be used such as an electromagnetic wave absorber. In other words, the material is regarded as an extremely desirable general-purpose material since it can be used not only as a soft magnetic product with high magnetic permeability but also as an electromagnetic wave absorber by choosing the frequency region, though it is a single material.

In the high-frequency magnetic material, it is preferred that the matrix phase is composed of oxide particles and the metal oxide having a larger valence than the matrix phase is present on particle boundaries of the oxide particles.

Also, the oxide having a larger valence than the matrix phase and forming completely a solid solution with the matrix phase is preferably contained in a content of 0.001 to 0.1%, more preferably 0.001 to 0.01% by mole based on the non-reducible metal oxide. FIG. 2 is a cross sectional view showing the high-frequency magnetic material of an example of the invention. A matrix phase of the high-frequency magnetic material 3 is composed of oxide particles 4, metal particles 1 are in the particle boundaries 5 and the interior of the oxide particles 4, and a metal oxide having a larger valence than the matrix phase (not shown) is present on the particle boundaries 5 of the oxide particles.

A producing method includes a step for manufacturing a precursor of a composite oxide, which contains a non-reducible metal oxide, a metal oxide containing at least one of Fe, Co and an alloy based on Fe or Co, and a metal oxide having a larger valence than the matrix phase and a step for subjecting the precursor to heat treatment under the reducing atmosphere.

According to the producing method, a high-frequency magnetic material excellent in magnetic property and heat reliability can be obtained with the good yield. Since the yield improves, it is effective in reduction of the producing cost.

The high-frequency magnetic material of the embodiment preferably has an average particle size of 10 nm to 1 μm, more preferably 100 nm to 500 nm.

Also, the oxide phase preferably includes a composite material in which an oxide containing at least one of Fe and Co, the non-reducible metal oxide, and the metal oxide having a larger valence is contained.

Further, the non-reducible metal oxide is preferably an oxide of an element selected from Mg, Al, Si, Ca, Zr, Ti, Hf, a rare earth element, Ba, and the metal oxide having a larger valence than the matrix phase is selected from Al₂O₃, Sc₂O₃, Cr₂O₃ and V₂O₃.

The non-reducible metal oxide referred herein means such a metal oxide that is hardly reduced to a metal in a hydrogen atmosphere at a temperature of from room temperature to 1,500° C. and at atmosphere pressure. Examples of the metal oxide include oxides of Mg, Al, Si, Ca, Zr, Ti, Hf, a rare earth element, Ba and Sr. The non-reducible metal oxide in the embodiment may be one kind of the aforementioned oxides or a combination of plural kinds thereof.

The composition of the composite oxide is preferably a solid solution under consideration of the degree of freedom in composition, and particularly preferably a complete solid solution. In the case where two or more kinds of non-reducible metal oxides are used, two or more kinds of composite oxides may be formed.

The metal oxide having a larger valence than the non-reducible metal oxide in the invention may be, for example, a metal oxide having three or more valences in the case where the non-reducible metal oxide is magnesium oxide (MgO), which has two valences (divalent). An oxide having three valences (trivalent) is particularly effective in the invention, and examples thereof include Al₂O₃, Sc₂O₃, Cr₂O₃ and V₂O₃.

When a metal oxide of such a large valence number dissolves in a non-reducible metal oxide to form a solid solution, the diffusion rate of the metallic cation in the oxide increases, thus enabling the deposition rate of the metal during reduction to increase. The content of the aforementioned oxide dissolved in the solid solution is from 0.001% to 0.1% in mol %. Among such compositions, those with contents of from 0.001% to 0.01% in mol % are particularly preferred. A larger amount dissolved in the solid solution is more advantageous from the viewpoint of diffusion rate, and it becomes possible to deposit a sufficient amount of metal particles with a low energy, whereby not only a low cost process can be realized, but also the metal particles can be deposited in a thermally stabilized adhesion state where the metal-particles are closely adhered to the surface as well as the inside of the oxide particles since surplus heat stress is not applied when the metal particles deposit at the surface as well as the inside of the oxide particles. However, on the other hand, an excessively large content unfavorably acts to hinder the formation of a dense structure in the synthesis of a composite oxide sintered body. The most appropriate content of the dissolved oxide that does not adversely affect the prevention of dense structure formation and can effectively enhance the diffusion rate of the metal ion is from 0.001 to 0.01% in mol %.

The oxide having a large valence all may be present as a solid solution with the non-reducible metal oxide, or in alternative, it may be present on the grain boundary or the surface of the non-reducible metal oxide. The metal oxide added to NgO is particularly preferably Sc₂O₃ because Sc₂O₃ can be dissolved in MgO in a large amount to form a solid solution to provide significant increase in diffusion rate of metallic cations.

In the embodiment, the average particle size of the oxide phase is preferably from 10 nm to 1 μm. Within this range, 100 nm to 500 nm is particularly preferred. When the average particle size of the oxide phase falls within the range of from 10 nm to 1 μm, and, in particular, from 100 nm to 500 nm, the resulting material is highly resistant to heat cycles and excels in long-term thermal magnetic properties.

In the manufacture of the high-frequency magnetic material according to the embodiment, it is preferred to go through a step of mixing, pulverizing and sintering a non-reducible metal oxide, a metal oxide having a larger valence than the non-reducible metal oxide, and a metal oxide containing at least one of Fe and Co to give rise to a composite oxide with an average particle size of from 10 nm to 1 μm, in particular, from 100 nm to 500 nm, and a reduction step of subjecting the composite oxide to reduction treatment to cause metal or alloy particles to deposit at the oxide phase particle boundaries and/or in the inside of the oxide particles. Owing to the fact that the average particle size of the composite oxide falls within the range of from 10 nm to 1 μm, in particular, from 100 nm to 500 nm, the adhesion of the deposited metal particles to the oxide phase becomes extremely strong during the step of reduction treatment, and a closely structured high-frequency magnetic material can be expected. In the case where the adhesion of the deposited metal particles to the oxide phase is firm, long-term thermal magnetic properties are excellent and since a dense structure can be formed, the useless volume can be reduced, enabling the miniaturization of a product.

Though each of the effect of the average particle size of the oxide phase and the dissolving effect of the trace amount metal oxide is effective independently, an enhanced effect can be attained by preferably achieving both. Namely, the average particle size of the oxide phase is controlled to be from 10 nm to 1 μm, in particular, from 100 nm to 500 nm, and at the same time the content of the metal oxide dissolved in the non-reducible metal oxide is controlled to fall within the range of from 0.001 to 0.1% in mol %, in particular from 0.001 to 0.01% in mol %. By these measures, a magnetic material having still more preferable high-frequency magnetic properties can be realized.

In the embodiment of the invention, the metal particles are preferably at least one of Fe particles, Co particles, FeCo alloy particles, FeCoNi alloy particles, Fe-base alloy particles and Co-base alloy particles. The Fe-base alloy and Co-base alloy is an alloy containing Ni, Mn, Cu and the like as a second component, for example, an FeNi alloy, an FeMn alloy, an FeCu alloy, a CoNi alloy, a CoMn alloy and a CoCu alloy, and also alloys obtained by adding Ni, Mn or Cu to an FeCo alloy. The metal particles can improve the high-frequency property. An oxide of Fe or Co is preferred since it can easily form a solid solution with the non-reducible metal oxide. The Fe-base particles are preferably such a system that is partly substituted by another element in view of oxidation resistance. Preferred examples of the system include an FeCo system, an FeCoNi system and an FeNi system, and the third element (another component) may further be substituted.

It is sufficient in the embodiment that at least one kind of Fe particles, Co particles, FeCo alloy particles, FeCoNi alloy particles, Fe alloy particles and Co alloy particles are contained as a metal particle. Another non-magnetic metallic element may be contained therein to form an alloy, but the saturation magnetization becomes too low in the case where the amount of the another non-magnetic metallic element (e.g., other reductive metals than Fe, Co, and Ni) is too large, and the amount thereof is preferably 10% by atom or less. The non-magnetic metal may be dispersed solely in the system, and the amount thereof is generally 20% or less in terms of volume ratio. It is preferred from the standpoint of oxidation resistance of the deposited microcrystals that the Fe-base particles partly contain Co or Ni, and FeCo particles are more preferred from the standpoint of saturation magnetization.

The oxide is preferably at least one of a magnesium oxide, an aluminum oxide, a potassium oxide, a silicon oxide, an rare earth metal oxide, a titanium oxide, a zirconium oxide, a barium oxide, a strontium oxide and a zinc oxide.

The oxide phase is preferably at least one of an FeMgO system, an FeCoMgO system, an FeCoNiMgO system, a CoMgO system, an FeAlO system, a CoAlO system, an FeCoAlO system and an FeCoNiAlO system.

The high-frequency magnetic material of the invention is preferably produced by a process containing a step of producing a composite oxide of powder of the non-reducible metal oxide (A) and powder of the metal oxide containing at least one of Fe and Co (B) with a molar ratio of the non-reducible metal oxide and the metal oxide containing at least one of Fe and Co (A/B) being from 1/9 to 9/1; and a step of reducing the composite oxide to deposit metal particles containing at least one of Fe, Co and an alloy based thereon in the interior or on the grain boundary of the composite oxide particles.

According to the aforementioned constitution, the embodiment can provide a high-frequency magnetic material excellent in magnetic property in a high yield. The production cost thereof can be effectively reduced owing to the improvement in yield.

The metal particles preferably have an average size of from 0.10 to 2,000 nm. In the case where the average particle size is less than 10 nm, the amount of magnetic flux may be insufficient due to occurrence of super paramagnetism. In the case where it exceeds 2,000 nm, on the other hand, the eddy current loss may be increased to deteriorate the magnetic property in a high frequency range, which is the target range of the invention. The average particle size is more preferably from 10 to 50 nm. When the particle size gets larger, not only eddy current loss occurs but also it becomes energetically more stable to assume a multiple magnetic domain structure than to assume a single domain structure. However, the high-frequency property of the magnetic permeability for multiple domain structure deteriorates compared with that for single domain structure. Thus, in the case of using as a high-frequency magnetic material, it is important to make magnetic metal particles exist as single magnetic domain particles. Since the critical particle size of keeping single domain structure is roughly 50 nm or less, it is more desirable to make the particle size not exceed 50 nm. By recapitulating these conditions, the average particle size of the metal particles should be desirably controlled within the range of from 10 to 2000 nm, in particular 10 to 50 nm.

Moreover, the high-frequency magnetic material of the present embodiment should preferably be polycrystalline. Being polycrystalline means that the material can be manufactured by a powder metallurgy process (sintering process), enabling cost reduction. By way of precaution, the deposited metal particles may be, single crystalline. By making the deposited metal particles single crystalline, it becomes easy to align the axis of easy magnetization, which enables control of crystalline magnetic anisotropy whereby the high-frequency properties improve compared to the case of polycrystals.

The metal particles are preferably present in at least one of the interior and the grain boundary of the crystal particles constituting the high-frequency magnetic material. In order to improve the high-frequency magnetic property, it is preferred that the metal particles are present in both the interior and the grain boundary of the crystal particles.

The crystals constituting the high-frequency magnetic material may contain, in addition to the non-reducible metal oxide crystals and the metal particles, crystals of a composite oxide (solid solution) of an oxide of a non-reducible metal and an oxide of Fe or Co. The high-frequency magnetic material according to a second embodiment of the invention contains the composite oxide remaining therein. The composite oxide means an oxide containing two or more kinds of metals as constitutional elements rather than such a material that is obtained by mixing two kinds of oxides and binding the mixture with a resin. A composite oxide and a material obtained by mixing and binding two kinds of oxides can be analyzed to distinguish from each other by X-ray diffraction, EPMA, EDX or the like.

The composite oxide of an oxide of a non-reducible metal and an oxide of Fe or Co is effective for controlling the magnetic property because it facilitates deposition of metal particles in the crystal particles in the reducing step described later. Examples of such a composite oxide that particularly facilitates deposition of the metal particles include a complete solid solution, and specific examples thereof include an FeMgO system, an FeCoMgO system, an FeCoNiMgO system and a CoMgO system, and also include at least one of an FeAlO system, a CoAlO system, an FeCoAlO system and an FeCoNiAlO system. These compounds are formed in the case where MgO or Al₂O₃ (or a composite metal oxide containing Mg or Al as a constitutional element) is used as the non-reducible metal oxide.

The high-frequency magnetic material described heretofore may be either of one subjected to reduction treatment in a powder state, one obtained by processing into a pressed powder form after subjected to reduction treatment in a powder state, one obtained by solidification with a resin or the like after subjected to reduction treatment in a powder state, or one obtained by being subjected to reduction treatment in a bulk state of a composite oxide which is in a powder state and with an average particle size of from 10 nm to 1 μm, in particular from 100 nm to 500 nm whereby the composite oxide is obtained by mixing, pulverizing and sintering the aforementioned non-reducible metal oxide, the aforementioned metal oxide having larger valence than no-reducible metal oxide, and a metal oxide containing at least one of Fe and Co.

The high-frequency magnetic material containing the aforementioned prescribed metal particles and non-reducible metal oxide exhibits excellent property even in a high frequency range of from 100 MHz to several GHz and a higher frequency range of 10 GHz of higher. Therefore, a high-frequency magnetic device using the high-frequency magnetic material is suitable as a high-frequency magnetic device, such as an inductor, a choke coil, a filter, a transformer and an electromagnetic wave absorbing material, used in a high frequency range of 100 MHz or higher, and further 1 GHz or higher.

The production process of the high-frequency magnetic material of the invention will be described. The high-frequency magnetic material of the invention is not particularly limited in production process thereof as far as the aforementioned constitutions are satisfied. A preferred example of the production process will be described below.

The production process preferably contains the following two steps.

Step 1: A composite oxide, such as a solid solution, of (A) powder of a non-reducible metal oxide and (B) powder of a metal oxide containing at least one of Fe and Co with a molar ratio of the non-reducible metal oxide and the metal oxide containing at least one of Fe and Co (A/B) being from 1/9 to 9/1 is produced.

Step 2: The composite oxide is reduced to deposit metal particles containing at least one of Fe, Co and an alloy based thereon in the interior or on the grain boundary of the composite oxide.

In the production process, a composite oxide is produced in the step 1, and then reduced in the step 2, so as to deposit prescribed metal particles.

The step 1 will be described. In the step 1, a composite oxide, such as a solid solution, of (A) powder of a non-reducible metal oxide, (B) powder of a metal oxide containing at least one of Fe and Co, and (C) an oxide having a larger valence than the non-reducible metal oxide (A) is produced. In the composite oxide, the molar ratio (A/B) of the non-reducible metal oxide (A) to the metal oxide containing at least one of Fe and Co (B) is from 1/9 to 9/1, and the molar ratio (A/C) of the non-reducible metal oxide (A) to the oxide (C) is from 1/0.001 to 1/0.1.

The metal oxide containing at least one of Fe and Co (B) is preferably ferrous oxide (FeO) and cobalt oxide (CoO). Iron oxide includes various stoichiometric forms, such as FeO, Fe₂O₃ and Fe₃O₄, and ferrous oxide (FeO). Among them FeO easily forms a composite oxide with the non-reducible metal oxide in a wide compositional range. For example, in the case where MgO is used as the non-reducible metal oxide, FeO and CoO are particularly preferred since they form a complete solid solution. In the case where a complete solid solution is formed, fine metal particles can be deposited in the crystal particles at an arbitrary proportion in the reducing step (step 2). Iron oxide with another valence may be partly contained, and in the case where a solid solution of an FeAlO system is formed, Fe₂O₃ is preferably used.

The metal oxide containing Fe or Co may be a composite metal oxide containing Ni, Cu or Mn, and the amount thereof may be 50% by mole or less for Ni, and 10% by mole or less for Cu or Mn, based on the amount of Fe. Examples of the composite oxide include such a composite metal oxide as CoFe₂O₄ and NiFe₂O₄, those having nickel oxide, copper oxide or manganese oxide separately added thereto, and those containing impurities.

The metal oxide (B) is such a metal oxide that contains Fe or Co capable of being reduced to a metal at a temperature of from 200 to 1,500° C. in a hydrogen atmosphere at atmosphere pressure, and can deposit metal oxide in the depositing step described later. Therefore, the metal oxide (B) containing at least one of Fe and Co (B) can be referred to as a reductive metal oxide (B).

The molar ratio (A/B) is preferably from 1/9 to 9/1. In the case where the amount of (A) is larger than a molar ratio (A/B) of 9/1, the proportion of the metal oxide (B) becomes small, and the magnetic interaction among the particles is decreased, whereby there are such cases where super paramagnetism occurs to deteriorate the property. In the case where the amount of (B) is larger than a molar ratio (A/B) of 1/9, the size of the crystal particles deposited in the reducing step becomes large, whereby the property at a high frequency is deteriorated to fail to obtain necessary magnetic property for a high-frequency magnetic core, an electromagnetic wave absorbing material and the like.

For that reason, it is preferred to mix A with B at a ratio of A/B=9/1 to 1/9, in particular, 2/1 to 1/2 where the content of the reduced metal in the magnetic particles can be appropriately suppressed, the coalition as well as the growth of the magnetic particles and can be suppressed, and, at the same time, a sufficient amount of metal can be deposited.

It is advantageous for the manufacture of a composite oxide with an average particle size of from 10 nm to 1 μm by the subsequent steps to use a raw material powder having an average particle size of submicron order, in particular from 10 nm to 100 nm for each of the non-reducible metal oxide (A), the reducing metal oxide (B) and the oxide (C) having a larger valence number than that of the non-reducible metal oxide (A).

In the step 1, a raw material powder preparing step is carried out, i.e., the non-reducible metal oxide (A), the reductive metal oxide (B) and the metal oxide (C) having a larger valence than the non-reducible metal oxide (A) are weighed to a prescribed molar ratio and mixed in a ball mill or the like to prepare raw material powder.

At this time the oxide (C) may be previously added to the non-reducible metal oxide (A) or may be in the form of a solid solution with the non-reducible metal oxide (A).

The raw material powder is then heated to a prescribed temperature to effect reaction. The conditions for the reaction, such as the heating temperature, may be appropriately determined depending on the raw material powder and the target properties, and for example, the raw material powder is press-molded and then sintered by heating to a temperature of from 600° C. to 1500° C. in an oxidizing atmosphere, in vacuum, or in an inert atmosphere such as Ar. Examples of the oxidizing atmosphere include the air and an inert gas atmosphere containing oxygen, and the raw material powder is preferably sintered in an inert atmosphere or in vacuum for preventing the oxygen amount from being fluctuated. In the case where precipitate obtained by chemical reaction is used as the raw material, finer raw material powder can be obtained, which is reflected to miniaturization of the crystal particles after suffering various process steps. Therefore, it is preferable to use the precipitate by chemical reaction.

The composite oxide obtained by the step 1 is not particularly limited in state, such as powder or a bulk material. The material obtained by the sintering method (powder metallurgical process) is a polycrystalline material irrespective to the state thereof, i.e., powder or a bulk material.

In cases where the average particle size of the composite oxide sintered body thus obtained is large, the body may be pulverized so as to have an average particle size of from 10 nm to 1 μm, when the size exceeds 1>m. But, it is preferred that the average particle size be from 10 nm to 1 μm already in the state of sintered body.

The resulting composite oxide is then subjected to the step 2, i.e., it is reduced to deposit metal particles containing at least one of Fe, Co and an alloy based thereon. The resulting composite oxide may be subjected to reduction such as hydrogen reduction and carbon monoxide reduction to deposit the metal particles in at least one of the interior and the grain boundary of the oxide particles. The composite oxide may be subjected to hydrogen reduction in the form of powder, a bulk material (such as pellets, rings and rectangular bodies) or pulverized powder obtained by pulverizing a bulk material, and the composite oxide in the form of powder (including pulverized powder) can provide fine metal particles in a uniformly dispersed state owing to the short reaction time. In the case where the composite oxide having been molded into a prescribed magnetic member shape is subjected to reduction, the subsequent process for producing the member can be simplified.

The temperature and the time for the hydrogen reduction are not particularly limited, and the temperature may be such a value that a part of the oxide is reduced with hydrogen. The temperature is preferably from 200 to 1,500° C., since in the case where the temperature is lower than 200° C., the rate of the reduction reaction is too low, and in the case where it exceeds 1,500° C., the metallic fine particles thus deposited grow in a short period of time. The reduction time may be determined in relation to the reduction temperature and may be from 10 minutes to 100 hours. The hydrogen atmosphere is preferably a flow state, and the flow rate thereof may be 10 cc/min or more. In the case where the reduction is carried out in a hydrogen flow, the metal particles can be easily deposited uniformly over the entire surface of the composite oxide.

In the case where the entire amount of Fe or Co in the composite oxide is deposited, the first embodiment is obtained, and in the case where the composite oxide remains partly, the second embodiment is obtained. The deposition amount of Fe or Co is preferably 40% or more, more preferably 50% or more with respect to the high-frequency magnetic material at a volume ratio, but not limited thereto.

As having been described, the production process of the invention contains a step of producing a composite oxide, and subsequently, a step of depositing metal particles by a reduction treatment. The metal particles thus deposited through reduction are uniformly dispersed owing to the use of the step of reducing the composite oxide.

Upon processing the high-frequency magnetic material into a high-frequency magnetic device, a sintered body may be subjected to machine processing, such as grinding and cutting, and powder may be compounded with a resin. A surface treatment may be effected thereto depending on necessity. In the case where the material is used as an inductor, a choke coil, a filter or a transformer, a wire is wound thereon.

As described in detail in the foregoing, the high-frequency magnetic material of the invention is suitable as various fields, such as an inductor, a choke coil, a filter, a transformer and an electromagnetic wave absorbing material. The high-frequency magnetic material of the invention has high versatility since the same material can be adapted to various fields.

### EXAMPLE

The invention will be described in more detail with reference to Examples and Comparative Examples below.

### Examples 1 to 8

A non-reducible metal oxide powder (A), such as MgO and Al₂O₃, a reductive metal oxide powder (B), such as FeO and CoO, and an oxide (C), such as aluminum oxide, scandium oxide, chromium oxide and vanadium oxide, having a larger valence than the non-reducible metal oxide (A) were weighed to obtain the compositions shown in Table 1 below, and mixed in a ball mill (at 300 rpm for 1 hour) to obtain mixed powder containing (A), (B) and (C). The resulting mixed powder was press-molded at a pressure of 1 t/cm² (98 MPa) to obtain a specimen in the form of pellets.

The resulting specimen was introduced in an air furnace, and it was degreased at 500° C. for 1 hour and continuously sintered at a temperature of from 600 to 1,500° C. for a period of from 6 to 8 hours, so as to produce an oxide solid solution (pellet specimen).

The pellet specimen thus sintered was pulverized and introduced in a hydrogen furnace. The temperature was increased to a prescribed temperature at a rate of 10° C. per minute under a stream of a hydrogen gas having a purity of 99.9% at a rate of 200 cc/min to effect reduction for a period of from 20 to 60 minutes. After cooling in the furnace, a high-frequency magnetic material according to the invention was obtained. The periods of time required for the respective production steps in Examples were 1 hour for dry mixing, 10 hours for sintering by heating (3 hours for increasing temperature, 3 hours for maintaining temperature and 4 hours for decreasing temperature), and 6 hours for reducing treatment (2 hours for increasing temperature, 1 hour for maintaining temperature and 3 hours for decreasing temperature), and the sum is 17 hours. The total process time including the mixing/degreasing process required for the all process was 25 hours in all Examples.

The resulting material was mixed with an epoxy resin (2% by weight), and the mixture was molded to a rectangular shape having a width of 4.4 mm, a length of 5 mm and a thickness of 1 mm and cured at 150° C. to obtain a specimen to be evaluated.

### Comparative Examples 1 to 3

A material obtained by binding FeAlSi particles with an epoxy resin was prepared as Comparative Example 1, a material obtained by binding carbonyl iron powder with an epoxy resin was prepared as Comparative Example 2, and an NiZn ferrite sintered body was prepared as Comparative Example 3.

### Comparative Example 4

In this comparative example, the material was manufactured via a mechanical alloying process similar to that set forth in JP-A-2001-358493. A mechanical alloying process was carried out by mixing 1 μm particle size Fe powder with 1 μm particle size MgO powder in such a manner that the mol % ratio be 6/4 for one hour to prepare a mixed powder, charging the mixed powder in a stainless steel vessel together with stainless steel balls, and blending for 100 hr at 300 rpm after substitution and sealing with argon gas. After the treatment, the mixed powder was introduced in a vacuum furnace. The temperature was elevated to 500° C. in 1 hr, and then reduction treatment was performed for 1 hr. The process time required for the above-described total manufacturing steps was 103 hr.

In this way, a powder for a high-frequency magnetic material as the raw material was prepared. The subsequent procedures are the same as in Examples 1 to 8.

### Comparative Example 5

The non-reducible metal oxide powder (A) and the reducible metal oxide powder (B) were weighed respectively so as to achieve the composition as shown in Table 1. The subsequent procedures are the same as in Examples 1 to 8.

As a high-frequency magnetic property, magnetic permeability was measured first of all. In the measurement of magnetic permeability, the real part of magnetic permeability μ′ was measured at 1 GHz. Further, for the evaluation of the long-term thermal magnetic property, after the sample was left for 1000 hr in a thermostat kept at a temperature of 60° C. and a relative humidity of 90% RH, the real part of magnetic permeability μ′ was again measured, which was compared with the initial value. Change caused by time elapse was shown by the ratio of the real part of magnetic permeability μ′ after 1000 hr leaving to that μ′ prior to the leaving.

Then, as the electromagnetic wave absorption property, the electromagnetic wave absorption for electromagnetic wave of 2 GHz was defined by the reflective decay amount, which was shown in relative basis with the reference value of 1 for the absorption amount in Comparative Example 1. The measurement was done with a sample on one surface of which electromagnetic wave was irradiated and a metal thin plate bonded to the opposite surface of the sample and having 1 mm thickness and the same area as that of the sample. And by means of a network analyzer in the S11 mode, the measurement based on the reflection power method was done in the free space. The reflection power method measures the decrease of the level of reflection from the sample in dB compared with the reflection level of the aforementioned metal thin plate not bonded to the sample (a perfect reflector).

Generally speaking, a high-frequency magnetic material, which exhibits substantially no loss except ferromagnetic resonance loss and a high magnetic permeability even in high-frequency regions, has a high μ′ and a low μ″ in the frequency region below its ferromagnetic resonance frequency, enabling applications as soft magnetic parts with high magnetic permeability such as inductance elements, etc. Further, at the vicinity of the ferromagnetic resonance frequency, it has a low μ′ and a high μ″, and can be used as an electromagnetic wave absorber. In other words, such a material can be used not only as a soft magnetic part with high magnetic permeability but also as a electromagnetic wave absorber by choosing the frequency bandwidth, though it is a single material. In the present evaluation of magnetic properties, μ′ was evaluated at 1 GHz to explore the possibility as a soft magnetic part with high magnetic permeability, and the electromagnetic wave absorption at 2 GHz was measured to explore the possibility as a electromagnetic wave absorber.

The measurement of the average crystalline particle size of the deposited metal particles was based on TEM observation. Specifically, the longest diagonal of the individual metal particles shown by TEM observation (photograph) was regarded as the particle size thereof, and such values were averaged. Meanwhile, TEM photographs of a unit area of 10 μm×10 μm were taken for three positions or more, and an average particle size was obtained.

The average particle size of the composite oxide prior to reduction was obtained by averaging the averaged value of the longest and shortest diagonals of individual particles at least over 100 particles based on SEM observation.

Table 1 shows the evaluation results including the magnetic permeability, change of the real part of magnetic permeability after 1000 hr, the electromagnetic wave absorbing property and the total process time and the like. It was understood from Table 1 that the high-frequency magnetic materials of Examples exhibited excellent magnetic capabilities. While the real part of the magnetic permeability was evaluated only at 1 GHz, it showed flat frequency characteristics, and substantially the same values were obtained at 100 MHz. The deposited metal particles in the high-frequency magnetic materials of Examples were at least one kind of Fe particles, Co particles, Fe alloy particles and Co alloy particles. The maximum size of the deposited metal particles was 2,000 nm or less in all Examples. The deposited metal particles were found in the interior and the grain boundary of the oxide particles.

The remaining phase of the composite oxide formed by sintering was observed by EPMA. No oxide phase was detected other than the solid solution in Examples 1, 2, 3 and 5. Segregation of the powder (C) was detected in a part of the surface of the grain boundary of the solid solution in the materials of Examples 4, 6, 7 and 8.

In Example 7, iron was detected in a part of the oxide particles.

TABLE 1

| | | | | | Average | | | Change | | |
|---|---|---|---|---|---|---|---|---|---|---|
| | | | | | particle | | | of real | | |
| | | | | | size of | Particle | | part of | Electo- | |
| | | | | | composite | size of | Real | magnetic | magnetic | |
| | | | | | oxide | deposited | part of | permeability | wave | Total |
| Example/ | | | | | before | metal | magnetic | after | absorbing | process |
| Comparative | Composition | Powder | Powder | Powder | reduction | particles | permeability | 1000 hr | property | time |
| Example | molar ratio) | (A) | (B) | (C) | (nm) | (Å) | (1 GHz) | (1 GHz) | (2 GHz) | (hr) |
| Example | 0.99996 | MgO | FeO | Al₂O₃ | 120 | 90 | 86 | 0.96 | 1.5 | 25 |
| 1 | (Fe_{0.6}Mg_{0.4} | | | | | | | | | |
| | )O | | | | | | | | | |
| | 0.00004 | | | | | | | | | |
| | Al₂O₃ | | | | | | | | | |
| Example | 0.99998 | MgO | FeO | Al₂O₃ | 115 | 80 | 85 | 0.97 | 1.5 | 25 |
| 2 | (Fe_{0/6}Mg | | | | | | | | | |
| | _{0.4})O | | | | | | | | | |
| | 0.00002 | | | | | | | | | |
| | Al₂O₃ | | | | | | | | | |
| Example | 0.99996 | MgO | FeO | Al₂O₃ | 2000 | 95 | 82 | 0.92 | 1.5 | 25 |
| 3 | (Fe_{0.6}Mg_{0.4} | | | | | | | | | |
| | )O | | | | | | | | | |
| | 0.00004 | | | | | | | | | |
| | Al₂O₃ | | | | | | | | | |
| Example | 0.999 | MgO | FeO | Al₂O₃ | 110 | 120 | 75 | 0.87 | 1.45 | 25 |
| 4 | (Fe_{0.6}Mg | | | | | | | | | |
| | _{0.4})O | | | | | | | | | |
| | 0.001 | | | | | | | | | |
| | Al₂O₃ | | | | | | | | | |
| Example | 0.99996 | MgO | FeO + | Sc₂O₃ | 115 | 150 | 85 | 0.94 | 1.55 | 25 |
| 5 | (Fe_{0.6} | | CoO | | | | | | | |
| | Co_{0.2}Mg_{0.2}) | | | | | | | | | |
| | O | | | | | | | | | |
| | 0.0004 | | | | | | | | | |
| | Sc₂O₃ | | | | | | | | | |
| Example | 0.999 | MgO | FeO + | Sc₂O₃ | 130 | 100 | 80 | 0.92 | 1.5 | 25 |
| 6 | (Fe_{0.6}Co_{0.2} | | CoO | | | | | | | |
| | Mg_{0.2})O | | | | | | | | | |
| | 0.001 | | | | | | | | | |
| | Sc₂O₃ | | | | | | | | | |
| Example | 0.999 | MgO | Fe₂O₃ | Al₂O₃ | 145 | 150 | 70 | 0.86 | 1.3 | 25 |
| 7 | (Fe_{0.8}Mg_{0.2} | | | | | | | | | |
| | )O | | | | | | | | | |
| | 0.001 | | | | | | | | | |
| | Al₂O₃ | | | | | | | | | |
| Example | 0.999 | MgO | FeO | V₂O₃ | 125 | 150 | 70 | 0.89 | 1.3 | 25 |
| 8 | (Fe_{0.8}Mg_{0.2} | | | | | | | | | |
| | )O | | | | | | | | | |
| | 0.001 | | | | | | | | | |
| | Al₂O₃ | | | | | | | | | |
| Comparative | FeAlSi + | — | — | — | — | — | 10 | 0.8 | 1 | — |
| Example | resin | | | | | | | | | |
| 1 | | | | | | | | | | |
| Comparative | carbonyl | — | — | — | — | — | 2 | 0.76 | 0.4 | — |
| Example | iron + | | | | | | | | | |
| 2 | resin | | | | | | | | | |
| Comparative | NiZn | — | — | — | — | — | 5 | 0.96 | 0.65 | — |
| Example | ferrite | | | | | | | | | |
| 3 | sintered | | | | | | | | | |
| | body | | | | | | | | | |
| Comparative | Fe _{0.6}Mg | MgO | Fe | — | — | 100 | 7 | 0.79 | 0.9 | 103 |
| Example | _{0.4} | | | | | | | | | |
| 4 | | | | | | | | | | |
| Comparative | (Fe _{0.6}Mg | MgO | FeO | — | 4000 | 120 | 54 | 0.80 | 1.1 | 25 |
| Example | _{0.4})O | | | | | | | | | |
| 5 | | | | | | | | | | |

Summarizing the results of Table 1 has revealed that, when the particle size of the composite oxide particles prior to reduction is from 10 nm to 1 μm, in particular from 100 nm to 500 nm, and when the content of the metal oxide (C) is from 0.001 to 0.1% in mol %, in particular from 0.001 to 0.01%, based on the non-reducible metal oxide (A), the magnetic properties excel, and that, when the particle size of the composite oxide particles prior to reduction is from 100 nm to 500 nm and when the content of the metal oxide (C) is from 0.001 to 0.01% in mol %, in particular from 0.001 to 0.01%, based on the non-reducible metal oxide (A), still better magnetic properties are attained. In the present example, the μ′ value at 1 GHz is high and thermal stability is also good, having a potential of applicability as a soft magnetic part with high magnetic permeability in 1 GHz region. Further, since it has excellent electromagnetic wave absorbing property at 2 GHz, too, it has a potential of usability as an electromagnetic wave absorber in 2 GHz region. In other words, it has been confirmed that, the present material can be used as a soft magnetic part with high magnetic permeability as well as an electromagnetic wave absorber by changing the use frequency region, though it is just a single material, thus showing an extensive general-purpose nature. In addition, the time required for the manufacturing procedure in the present example is short compared with that of mechanical alloying processes, enabling the manufacturing yield to improve.

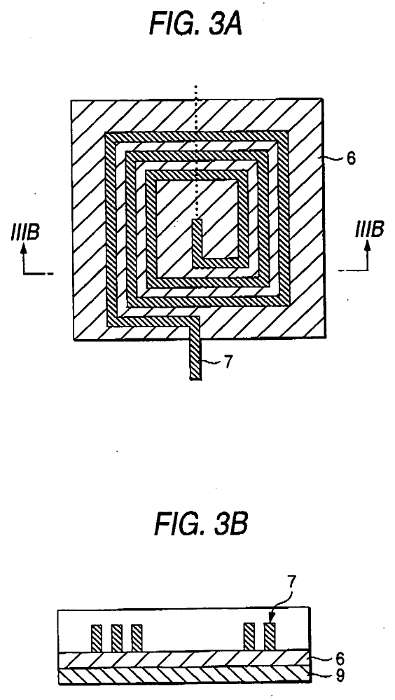

FIGS. 3A and 3B show an inductor as an example of a high-frequency magnetic device, in which a high-frequency magnetic substrate 6 made of the high-frequency material is provided on a magnetic layer 9 and a wiring 7 is built on the substrate. When the high-frequency magnetic material is used as a high-frequency magnetic substrate, the high-frequency magnetic material may be adapted to a flexible substrate by adding resins. A suitable material (not shown) may cover the surface of the high-frequency magnetic substrate 6.

The invention provides a high-frequency magnetic material having excellent magnetic property in a high yield owing to the aforementioned constitution. The invention is effective for reducing the production cost because of the improved yield.

As having been described, the invention can provide such a novel high-frequency magnetic material that exhibits sufficient property in a high frequency range of 1 GHz or higher and is excellent in production yield.

What is claimed is:

1. A high-frequency magnetic material comprising:
metal particles of one of Fe and Co or alloy particles based on at least one of Fe and Co; and
an oxide phase comprising a matrix phase of a non-reducible metal oxide and a metal oxide having a larger valence than the non-reducible metal oxide, the metal oxide having a larger valence than the non-reducible metal oxide forming a solid solution with the matrix phase.

2. The high-frequency magnetic material according to claim 1, wherein the matrix phase is composed of a plurality of particles of the non-reducible metal oxide, and a metal oxide which is the same as the metal oxide having a larger valence than the matrix phase is present on a grain boundary of the plurality of particles of the non-reducible metal oxide.

3. The high-frequency magnetic material according to claim 1, wherein the metal oxide having a larger valence than the matrix phase has a content of from 0.001 to 0.1% by mole based on the non-reducible metal oxide.

4. The high-frequency magnetic material according to claim 2, wherein the particles of the non-reducible metal oxide has an average particle size of 10 nm to 1 μm.

5. The high-frequency magnetic material according to claim 1, wherein the oxide phase contains a composite oxide, the composite oxide comprising:
an oxide comprising at least one of Fe and Co;
the non-reducible metal oxide; and
the metal oxide having a larger valence than the matrix phase.

6. The high-frequency magnetic material according to claim 1, wherein the non-reducible metal oxide is an oxide of an element selected from the group consisting of Mg, Al, Si, Ca, Zr, Ti, Hf, a rare earth element, Ba and Sr, and the metal oxide having a larger valence than the matrix phase is selected from the group consisting of Al₂O₃, Sc₂O₃, Cr₂O₃ and V₂O₃.

7. A method for producing a high-frequency magnetic material, comprising:
obtaining a composite oxide having an average particle size of 10 nm to 1 μm by mixing, pulverizing and sintering a non-reducible metal oxide, a metal oxide selected from Al₂O₃, Sc₂O₃, Cr₂O₃ and V₂O₃ in a content of 0.001 to 0.1% by mole based on the non-reducible metal oxide, and a metal oxide containing at least one of Fe and Co; and
reducing the composite oxide to deposit a metal or alloy particles containing at least one of Fe and Co.

8. A high frequency magnetic device comprising:
a magnetic layer;
a high-frequency magnetic material comprising:
metal particles of one of Fe and Co or alloy particles based on at least one of Fe and Co; and
an oxide phase comprising a matrix phase of a non-reducible metal oxide and a metal oxide having a larger valence than the non-reducible metal oxide, the metal oxide having a larger valence than the non-reducible metal oxide forming a solid solution with the matrix phase; and
a wiring on the high-frequency magnetic substrate.

9. The high-frequency magnetic device according to claim 8, wherein the matrix phase is composed of a plurality of particles of the non-reducible metal oxide, and a metal oxide which is the same as the metal oxide having a larger valence than the matrix phase is present on a grain boundary of the plurality of particles of the non-reducible metal oxide.

10. The high-frequency magnetic device according to claim 8, wherein the metal oxide having a larger valence than the matrix phase has a composition of from 0.001 to 0.1% by mole based on the non-reducible metal oxide.

11. The high-frequency magnetic device according to claim 9, wherein the particles of the non-reducible metal oxide has an average particle size of 10 nm to 1 μm.

12. The high-frequency magnetic device according to claim 8, wherein the oxide phase contains a composite oxide, the composite oxide comprising:
an oxide comprising at least one of Fe and Co;
the non-reducible metal oxide; and
the metal oxide having a larger valence than the matrix phase.

13. The high-frequency magnetic device according to claim 8, wherein the non-reducible metal oxide is an oxide of an element selected from the group consisting of Mg, Al, Si, Ca, Zr, Ti, Hf, a rare earth element, Ba and Sr, and the metal oxide having a larger valence than the matrix phase is selected from the group consisting of Al₂O₃, Sc₂O₃, Cr₂O₃ and V₂O₃.
